(19) United States
(12) Patent Application Publication
(10) Pub. No.: US 2024/0380118 A1
(43) Pub. Date: Nov. 14, 2024

(54) DIELECTRIC ROD ANTENNA ASSEMBLY

(71) Applicant: E M Solutions Pty Ltd, Yeronga, Queensland (AU)

(72) Inventors: John Brian Ness, pullenvale (AU); Sabin Kaibasic, Tennyson (AU)

(21) Appl. No.: 18/692,772

(22) PCT Filed: Sep. 19, 2022
(86) PCT No.: PCT/AU2022/051123

§ 371 Date: Mar. 15, 2024

(30) Foreign Application Priority Data
Sep. 17, 2021 (AU) 2021902999

(51) Int. Cl. H01Q 13/24; H01Q 1/36; H01Q 21/00

(52) U.S. Cl. CPC H01Q 13/24; H01Q 1/36; H01Q 21/0068

(57) ABSTRACT

A dielectric rod antenna assembly including a single waveguide arranged to direct electromagnetic energy into a plurality of dielectric rod antennas, and a plurality of dielectric rod antennas connected to the single waveguide.

### TECHNICAL FIELD

The present invention relates to a dielectric rod antenna assembly. In particular, but not exclusively, the present disclosure relates to a compact, high gain, multiple rod dielectric antenna in the form of a dielectric rod antenna assembly having a plurality of dielectric rods.

### BACKGROUND

Any references to methods, apparatus or documents of the prior art are not to be taken as constituting any evidence or admission that they formed, or form part of the common general knowledge.

A dielectric rod antenna for RF (radio frequency), microwave and mm wave frequencies typically has a substantially conical or frustum shape. In the large diameter section of the antenna the signal is effectively bound by the interface between the dielectric rod and the surrounding air to provide a guided wave. To get the antenna to radiate the signal, the rod diameter is gradually tapered down to a much smaller diameter causing the energy to leave the rod and so act as an antenna.

The dielectric rod antenna (a subset of the surface wave antenna family) has been researched for many years and design equations and methods are summarised in (Zukker, 1969). Despite the research, the dielectric rod antenna has not found extensive use compared to the more conventional metal antennas which exist in a wide variety of forms ranging from wire and plate constructions at RF and lower microwave frequencies through to horns and reflectors at higher microwave and mm wave frequencies.

The gain, that is, the ability to concentrate the beam, of a dielectric rod antenna is increased by increasing the length of the radiating taper section and it is possible to realise gains of 20 dB and even 25 dB by this method. To get higher gain, the dielectric rod antenna can be used as the feed antenna for a parabolic reflecting antenna and in this case antenna gains from 20-50 dB are readily realised.

However, it would appear that dielectric rod antennas either as standalone units or as a feed for parabolic reflector antennas have found very limited applications. The reasons for this relate to the following issues with dielectric rod antennas:
1. The loss in the dielectric material. A dielectric rod waveguide made from even the lowest loss dielectric materials such as Teflon, pure silica, aluminium oxide etc have more loss than a metal waveguide per unit length;
2. There is little control over the pattern emitted by the dielectric rod antenna. The gain is controlled to some extent by the length of the radiating taper but this is also relatively limited;
3. The position and length of the section of the dielectric rod antenna that strongly radiates is frequency dependent so the frequency bandwidth may be rather limited especially if using the dielectric rod antenna as a feed for a parabolic reflector. If the position of the main radiating section shifts along the rod with frequency this corresponds to the phase centre of the feed shifting which makes it difficult to maintain good antenna patterns over a wide bandwidth with parabolic reflector antennas; and
4. The loss per unit length and the tapering of the radiating section can severely limit the maximum power that can be transmitted via a dielectric rod antenna due to heating in the dielectric material.

Some existing designs for dielectric rod antennae utilise multiple rods including a central rod as the main antenna feed surrounded by a number of rods used for tracking, where each rod is fed by a separate square waveguide. However, such designs are not suitable or optimised for high gain applications.

### SUMMARY OF INVENTION

In an aspect, the invention provides a dielectric rod antenna assembly comprising:
a single waveguide arranged to direct electromagnetic energy into a plurality of dielectric rod antennas; and
a plurality of dielectric rod antennas connected to the single waveguide.

Preferably, the single waveguide is a common dielectric waveguide.

Preferably, each of the plurality of dielectric rod antennas comprises a radiating dielectric rod. More preferably, each of the plurality of dielectric rod antennas comprises a radiating dielectric rod aperture.

Preferably, the dielectric rod antenna assembly comprises two or more radiating dielectric rod apertures or dielectric rod antennas connected to the single waveguide (or common dielectric waveguide). Preferably, the dielectric rod antenna assembly comprises at least four radiating dielectric rod apertures or dielectric rod antennas connected to the single waveguide. More preferably, for tracking applications, the dielectric rod antenna assembly comprises between four and eight radiating dielectric rod apertures or dielectric rod antennas connected to the single waveguide (or common dielectric waveguide).

Preferably, the single waveguide is connected to each of the plurality of dielectric rod antennas. In use, the plurality of dielectric rod antennas generates a single, high gain beam.

Preferably, the dielectric rod antenna assembly comprises a matching section. Preferably, the matching section is located at an input of the plurality of dielectric rod antennas.

Preferably, the dielectric rod antenna assembly comprises between 2 and 12 dielectric rod antennas connected to the single waveguide. More preferably, the dielectric rod antenna assembly comprises between 4 and 8 dielectric rod antennas connected to the single waveguide.

Preferably, the plurality of dielectric rod antennas are spaced apart in a circular array. This is particularly suitable for tracking applications. More preferably, the plurality of dielectric rods are spaced equidistantly in a circular array. Preferably, the plurality of dielectric rod antennas are arranged symmetrically in a circular array. Preferably, the plurality of dielectric rod antennas are arranged in radial symmetry (i.e. arranged around a central axis). Alternatively, the dielectric rod antennas are spaced apart in a square or rectangular array.

In an aspect, the invention provides a dielectric rod antenna assembly comprising:

a single waveguide arranged to direct electromagnetic energy into a plurality of dielectric rod antennas; and
a plurality of dielectric rod antennas connected to the single waveguide,
whereby a gain of the antenna assembly is greater than a gain of an antenna assembly having a single dielectric rod antenna, wherein each of the plurality of dielectric rod antennas and the single dielectric rod antenna are of equal length.

In another aspect, the invention provides a dielectric rod antenna assembly comprising a plurality of dielectric rod antennas configured to connect to a common dielectric waveguide.

In another aspect, the invention provides a parabolic reflector antenna system comprising a dielectric rod antenna assembly having a plurality of dielectric rod antennas connected to a single waveguide.

In another aspect, the invention provides a dielectric rod antenna assembly comprising:
a single waveguide arranged to direct electromagnetic energy into a plurality of dielectric rod antennas; and
a plurality of dielectric rod antennas connected to the waveguide.

In another aspect, the invention provides a dielectric rod antenna assembly comprising:
a common dielectric waveguide arranged to direct electromagnetic energy to or from a plurality of dielectric rod antennas; and
a plurality of dielectric rod antennas connected to the common dielectric waveguide.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates an 8-element dielectric rod antenna according to an embodiment of the present invention;

FIG. 2 illustrates a cross-section of the 8-element dielectric rod antenna shown in FIG. 1 connected to a waveguide;

FIG. 3 illustrates a 4-element dielectric rod antenna according to an embodiment of the present invention;

FIG. 4 is a graph showing a comparison of gain v frequency between a single dielectric rod antenna and an 8-element dielectric rod antenna;

FIG. 5 is a graph showing a comparison of 3 dB beamwidth vs frequency between a single dielectric rod antenna and an 8-element dielectric rod antenna;

FIG. 6 is a graph showing a comparison of phase centre position vs frequency between a single dielectric rod antenna and an 8-element dielectric rod antenna;

FIG. 7 illustrates the projected temperature of the single dielectric rod antenna with a 20 W 30 GHz excitation;

FIG. 8 illustrates the projected temperature of the 8-element dielectric rod antenna with a 20 W 30 GHz excitation;

FIG. 9 illustrates a cross-section of a parabolic reflector antenna having a dielectric rod antenna located thereon;

FIG. 10 illustrates an 8-element dielectric rod antenna according to another embodiment of the present invention;

FIG. 11 illustrates a cross-section of the 8-element dielectric rod antenna shown in FIG. 10;

FIG. 12 illustrates an 8-element dielectric rod antenna according to another embodiment of the present invention; and

FIG. 13 illustrates a cross-section of the 8-element dielectric rod antenna shown in FIG. 12.

### DETAILED DESCRIPTION OF PREFERRED EMBODIMENTS

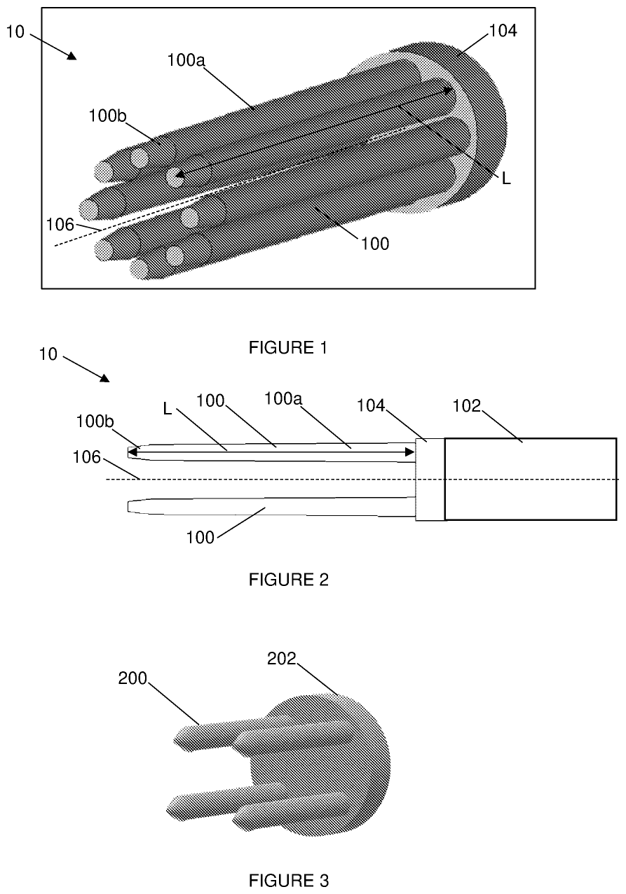

FIGS. 1-3 illustrate a dielectric rod antenna which can be used as a standalone antenna and as a wideband feed for a parabolic reflector antenna. This design substantially reduces the problems associated with existing dielectric rod antennae while also providing full circular symmetry, either linear or circular polarisation operation and higher order mode tracking capability of a parabolic reflector antenna implementation.

FIGS. 1 and 2 illustrate a dielectric rod antenna assembly 10 having a plurality of dielectric rod antennas 100 connected to a single waveguide 102.

In the illustrated embodiment, the dielectric rod antenna assembly 10 includes eight dielectric rod antennas 100 (in the form of eight radiating dielectric rod apertures) connected to the single waveguide 102 (in the form of a common dielectric waveguide) and a matching section 104, whereby the gain of the dielectric rod antenna assembly 10 is greater than an antenna assembly having a single dielectric rod antenna of equal length. That is, an antenna assembly having eight dielectric rod antennas, each having a length L, will have a gain greater than an antenna assembly having a single dielectric rod antenna with length L.

Furthermore, the dielectric rod antenna assembly 10 has been found to have a gain greater than a single dielectric rod antenna assembly which has a much greater length. Put another way, a length of the eight dielectric rods 100 of the dielectric rod antenna assembly 10 (where all eight rods are the same length) is less than a length of an antenna assembly with a single dielectric rod antenna, where both assemblies provide the same gain.

The operational advantage of the dielectric rod antenna assembly 10 disclosed herein is such that a ratio of the gain to the length of the dielectric rod antenna assembly 10 is greater than a ratio of the gain to the length of an antenna assembly with a single dielectric rod antenna.

While the embodiment illustrated in FIG. 1 includes eight dielectric rod antennas to maintain full circular symmetry for higher order mode antenna tracking, it has been found that any number of rods equal to or greater than two (e.g. 2, 3, 4, 5, 6, 7, 8, 9, 10, 11, 12 and so on) can be used.

In some particular embodiments, the dielectric rod antenna assembly 10 includes two or more radiating dielectric rod apertures or dielectric rod antennas connected to the single waveguide 102 (or common dielectric waveguide). The dielectric rod antenna assembly may also include at least four radiating dielectric rod apertures or dielectric rod antennas connected to the single waveguide. In some embodiments, the dielectric rod antenna assembly includes between four and eight radiating dielectric rod apertures or dielectric rod antennas connected to the single waveguide (or common dielectric waveguide).

Further to the above, the dielectric rod antenna assembly may include between 2 and 12 dielectric rod antennas connected to the single waveguide. More preferably, the dielectric rod antenna assembly may includes between 4 and 8 dielectric rod antennas connected to the single waveguide.

The single waveguide 102 is arranged to direct electromagnetic energy into the plurality of dielectric rod antennas 102 that are connected thereto.

More particularly, tin the illustrated embodiment, he single waveguide 102 is a circular waveguide which supplies electromagnetic waves to or from each of the eight dielectric rod antennas 100, such that each of the eight dielectric rod antennas 100 operate independently of one another.

However, the single waveguide 102 could take any polygonal form, including a square, hexagon or octagon, for example.

The eight dielectric rod antennas 100 are symmetrically arranged and are spaced apart equally, relative to one another) in a circular array. As can be seen in the illustrated embodiment, the eight dielectric rod antennas 100 are arranged in radial symmetry around a central axis 106 without a central rod.

Each of the eight dielectric rod antennas 100 includes an elongate cylindrical shaft 100a and a circular frustum head 100b at a distal end relative to the matching section 104.

The matching section 104 is provided at an input end of the tapered dielectric rod antennas 100. It will be appreciated that the matching section 104 may be omitted in some embodiments.

With reference to FIG. 3, an alternative embodiment of a dielectric rod antenna assembly 20 is shown having four dielectric rod antennas 200. This embodiment is substantially similar to dielectric rod antenna assembly 10. However, four dielectric rod antennas 200 are equally spaced apart in a square array, rather than a circular array as in dielectric rod antenna assembly 10. Although it will be understood a square array fits on the circumference of a circle and may also be considered to be arranged in a circular array.

Dielectric rod antenna assembly 20 also includes a single circular waveguide 202 which feeds each of the four dielectric rod antennas 200. Dielectric rod antenna assembly 20 may also include a matching section (similar to matching section 104 described above) in some embodiments.

The Inventor has found that replacing the single dielectric rod with a multiple array of tapering rods is advantageous for achieving high gain (and in particular, a single high gain beam) in a compact form factor (i.e. reducing the overall size of the rod as compared to a single rod configuration). The Inventor has also found that four rods (see FIG. 3) will provide the full circular symmetry required for the fundamental mode but in the case of higher order mode tracking, it is preferable to use eight individual rods as shown in FIGS. 1 and 2.

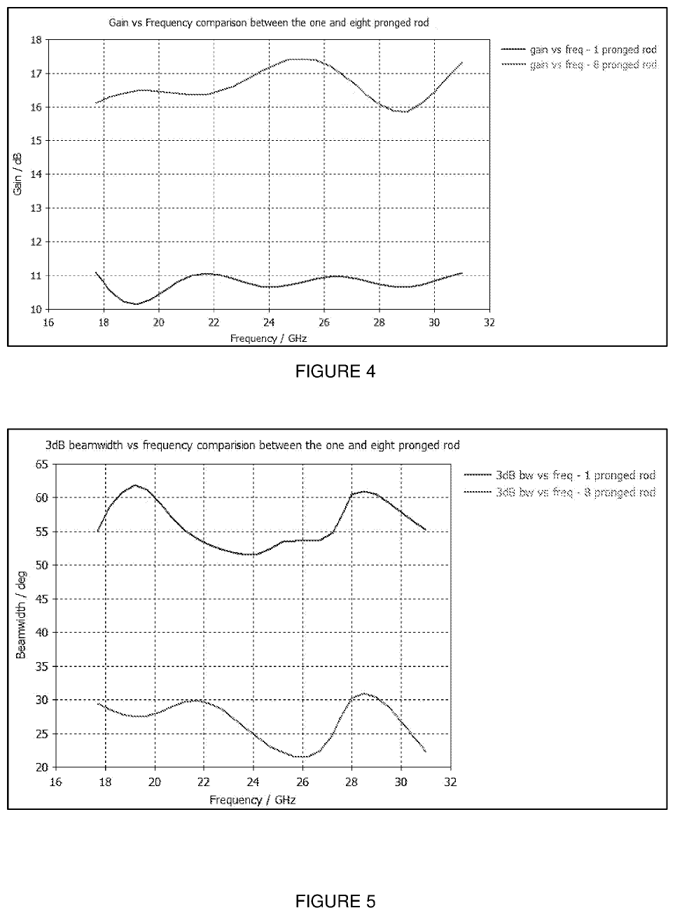

The primary effect on gain in the illustrated embodiment shown in FIG. 1 is a marked increase in the achievable gain for an equivalent length compared to a single rod. The gain and the beamwidth have greater degrees of freedom in that the gain can be controlled not only by the length and rate of the rod but also by the number and spacing of the array of rods. The gain and beamwidth for the same length of a single rod and an eight (8) rod array are compared in FIGS. 4 and 5. The higher gain and smaller beamwidth of the four and eight rod arrays make these configurations more suitable as feed antennas for parabolic reflector antenna systems.

Turning to the effects on bandwidth of the embodiments disclosed herein, the location of the main radiating section, equivalent to the phase centre when used as a feed element, is represented as a function of frequency for the single (1), four (4) and eight (8) rod arrays. It has been found that the position of the phase centre is much less dependent on frequency with the 4 or 8 rod array compared to the single element or rod. Consequently, when used as a feed for parabolic reflector antennas, the antenna gain and pattern will be less dependent on frequency than for a single dielectric rod feed.

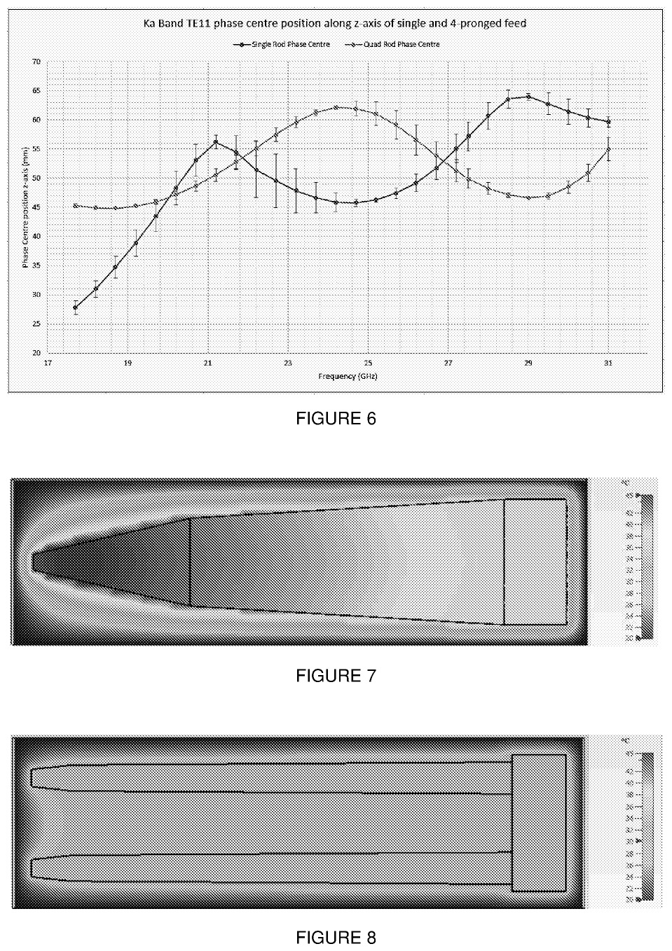

FIG. 6 shows the stability of the phase centre in the four dielectric rod array compared to a single dielectric rod. As can be seen in the figure, the four dielectric rod array has a stable phase centre within a 10 mm range across a higher frequency band whereas the single rod has a much higher variation of around 40 mm. As it will surely be appreciated, a stable phase centre (i.e. lower variation) is desirable for accurate positioning and maintaining good antenna patterns over a wide bandwidth, particularly in parabolic reflector antennas.

It should be appreciated by the person skilled in the art that the phase centre position was optimised for 17.70-21.20 GHz and 27.50-31 GHz in the illustrated example and thus the phase centre position is more collocated at these frequencies.

Power handling capability is determined by the maximum temperature that the dielectric material can withstand. The power absorbed in the dielectric material is a complex function of the dielectric constant, the dielectric loss tangent, the frequency and power level. The maximum temperature attained in the material is again a complex function of the thermal properties of the dielectric material, the size and shape and the air flow over the dielectric rod.

In the multi-rod arrays used in the embodiments disclosed herein, the power and thus the power loss and subsequent heating is distributed over multiple elements/rods, thereby reducing power loss and maximum temperature in the dielectric material and thus improving both the operating lifetime of the dielectric material and the operating efficiency of the rod antennas.

The projected temperatures in a single rod and an eight rod array for a given dielectric material at a frequency of 30 GHz and power input of 20 Watts are shown in FIGS. 7 and 8. The single rod has a maximum temperature of approximately 45° C. while the eight rod array has a maximum temperature of approximately 30° C. Thus, it can be seen that the eight rod array (shown in FIG. 8) is approximately 15° C. lower in temperature compared to the single element/rod (shown in FIG. 7) assuming passive air cooling. This demonstrates a significant reduction in operating temperature.

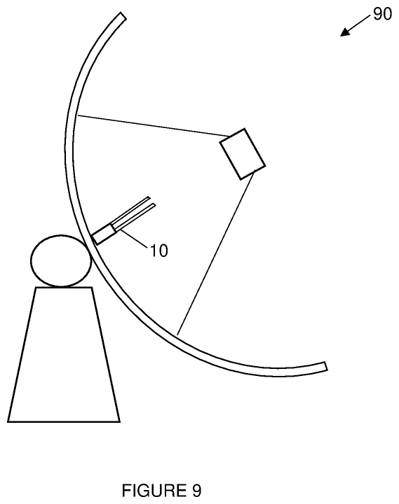

Turning to FIG. 9, there is illustrated a parabolic reflector antenna system 90 having a parabolic reflector 900 fitted with a dielectric rod antenna assembly 10 having eight dielectric rod antennas, as described above. In particular, the dielectric rod antenna assembly 10 includes a single waveguide connected to a plurality of dielectric rod antennas.

Turning now to consideration of feeding and tapering methods for a multi-rod antenna, the simplest way to couple in and out of a dielectric rod antenna is to mount the dielectric inside a waveguide (typically circular) and to taper the rod to obtain a good match over a wide frequency range. The configuration of the multi rod antennae described herein include one larger matching section feeding into multiple separate rods similar to a power divider/combiner. The distribution of E-fields and H-fields in the multi rod antenna predominantly propagate in the free space between the rods.

An abrupt transition between the dielectric loaded circular waveguide and the multi rod section (see FIGS. 1, 2 and 3, for example) generally results in a poorly matched transition that suffers from a low return loss (RL).

The RL of the transition can be improved using one of two designs described below. Both designs involves sizing a diameter of the matching to allow for both the dominant and tracking circular waveguide mode to propagate but this is achieved in two different ways.

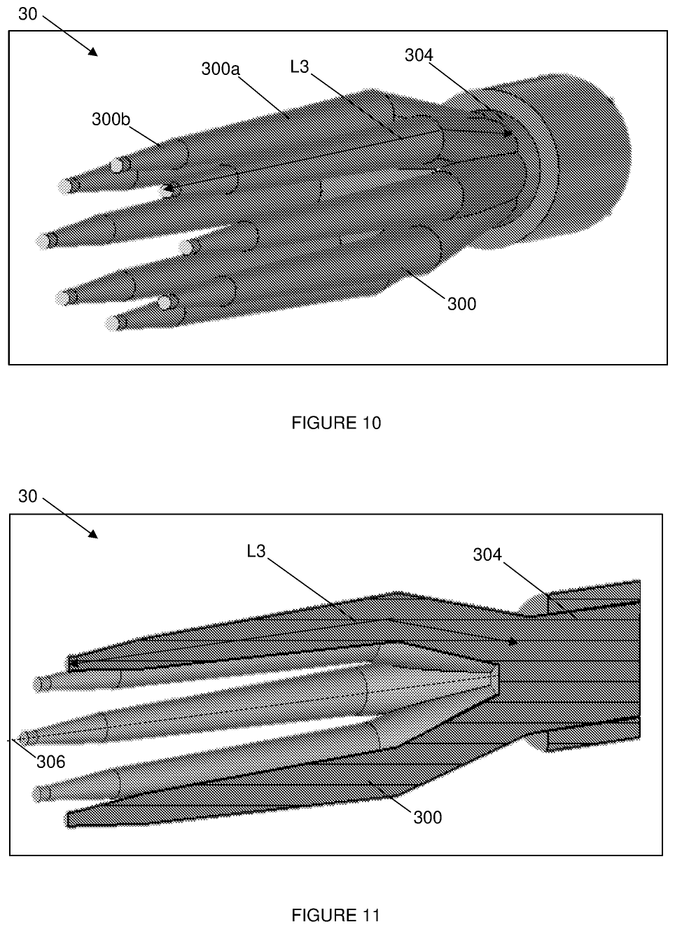

One approach, illustrated in FIGS. 10 and 11, includes the outward tapering of the rods. More specifically, the rods of the multi rod antenna are tapered outwards from the matching section. The outward tapering of the rods from the matching section improves the match in the transition between fully-filled waveguide and the free space between the rods. This feeding method and transition typically provides a RL greater than 20 dB.

The embodiment shown in FIGS. 10 and 11 includes a dielectric rod antenna assembly 30 having eight dielectric rod antennas 300 (in the form of eight radiating dielectric rod apertures) connected to a single waveguide (not shown) (in the form of a common dielectric waveguide) and a matching section 304, whereby the gain of the dielectric rod antenna assembly 30 is greater than an antenna assembly having a single dielectric rod antenna of equal length. That is, an antenna assembly having eight dielectric rod antennas, each having a length L3, will have a gain greater than an antenna assembly having a single dielectric rod antenna with length L3.

The eight dielectric rod antennas 300 are substantially conical (or frustoconical) in shape and diverge relative to the where a base of each dielectric rod antenna 300 connects to the matching section 304. That is, a distance between the bases of two of the eight dielectric rod antennas 300 is less than a distance between the tips of the two of the eight electric dielectric rod antennas 300.

The eight dielectric rod antennas 300 are symmetrically arranged and are spaced apart equally, relative to one another) in a circular array. As can be seen in the illustrated embodiment, the eight dielectric rod antennas 300 are arranged in radial symmetry around a central axis 306 without a central rod.

Each of the eight dielectric rod antennas 300 includes an elongate, substantially cylindrical shaft 300a and a circular frustum head 300b at a distal end relative to the matching section 304.

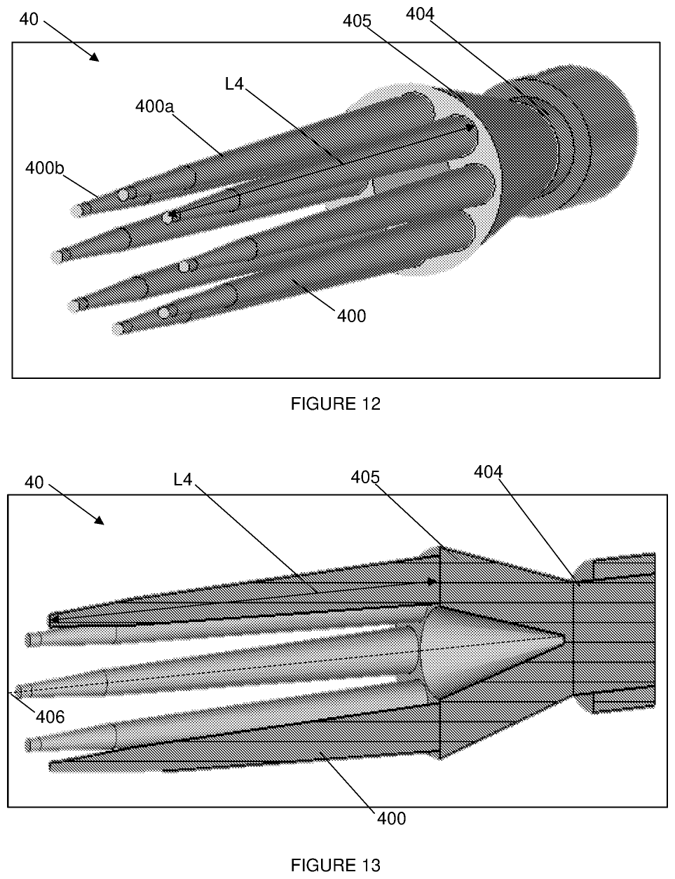

A second approach, illustrated in FIGS. 12 and 13, includes an inverted cone feeding method. More specifically, a taper section between the rods and the matching section provides a smooth transition from a fully-filled waveguide to the rods and provides a large dielectric face to attach each rod. The taper section includes an inverted cone portion to improve the match between the fields propagating through the dielectric portion and the transition to free-space between the rods. This feeding method and transition typically provides a RL greater than 20 dB.

The embodiment shown in FIGS. 12 and 13 includes a dielectric rod antenna assembly 40 having eight dielectric rod antennas 400 (in the form of eight radiating dielectric rod apertures) connected to a single waveguide (not shown) (in the form of a common dielectric waveguide) and a matching section 404, whereby the gain of the dielectric rod antenna assembly 40 is greater than an antenna assembly having a single dielectric rod antenna of equal length. That is, an antenna assembly having eight dielectric rod antennas, each having a length L4, will have a gain greater than an antenna assembly having a single dielectric rod antenna with length L4.

The eight dielectric rod antennas 400 are substantially conical (or frustoconical) in shape and are connected to the matching section 404 by an intermediary tapering portion in the form of a conical portion 405. A maximum diameter of the conical portion 405 connects to the eight dielectric rod antennas 400 and an apex of the conical portion 405 connects to the matching section 404.

The eight dielectric rod antennas 400 are symmetrically arranged and are spaced apart equally, relative to one another) in a circular array. As can be seen in the illustrated embodiment, the eight dielectric rod antennas 400 are arranged in radial symmetry around a central axis 406 without a central rod.

Each of the eight dielectric rod antennas 400 includes an elongate cylindrical shaft 400a and a circular frustum head 400b at a distal end relative to the matching section 404.

As the electromagnetic performances of both feeding and tapering designs are quite similar, the Inventors envision the choice of configuration will mainly be decided by the selected dielectric material and the available manufacturing methods for that configuration.

Antenna assemblies 20, 30, 40 can also be used with a parabolic reflector antenna system (as shown in FIG. 9, for example) having a parabolic reflector fitted with a dielectric rod antenna assembly.

As evidenced in the preceding sections, the four and eight rod antenna array provide higher gain and smaller beamwidth. This higher gain and smaller beamwidth make these configurations more suitable as feed antennas for parabolic reflector antenna systems to thereby improve the operation of the parabolic antenna.

Furthermore, as discussed above, the relatively, and objectively, stable phase centre (i.e. lower variation) provided by the four and eight rod antenna configuration is particularly useful in parabolic reflector antennas for accurate positioning and maintaining good antenna patterns over a wide bandwidth.

Advantageously, embodiments of the present invention provide gain of up to 20 dB without dramatically increasing the length of the dielectric rods. In addition, as demonstrated above, the embodiments of the present invention described herein provide improved bandwidth and power capability compared to the known single rod antenna systems.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step, etc.

The above detailed description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

The entirety of Australian provisional patent application number 2021902999 is incorporated herein by reference.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Throughout the specification and claims (if present), unless the context requires otherwise, the term “substantially” or “about” will be understood to not be limited to the specific value or range qualified by the terms.

1. A dielectric rod antenna assembly comprising:
a single waveguide arranged to direct electromagnetic energy into a plurality of dielectric rod antennas; and
a plurality of dielectric rod antennas connected to the single waveguide.

2. The dielectric rod antenna assembly of claim 1, wherein the single waveguide is a common dielectric waveguide.

3. The dielectric rod antenna assembly of claim 1, wherein the dielectric rod antenna assembly comprises two or more dielectric rod antennas connected to the single waveguide.

4. The dielectric rod antenna assembly of claim 1, wherein the dielectric rod antenna assembly comprises at least four radiating dielectric rod apertures connected to the single waveguide.

5. The dielectric rod antenna assembly of claim 1, wherein the dielectric rod antenna assembly comprises between 2 and 12 dielectric rod antennas connected to the single waveguide.

6. The dielectric rod antenna assembly of claim 1, wherein the dielectric rod antenna assembly comprises between 4 and 8 dielectric rod antennas connected to the single waveguide.

7. The dielectric rod antenna assembly of claim 1, wherein each of the plurality of dielectric rod antennas comprises a radiating dielectric rod.

8. The dielectric rod antenna assembly of claim 1, wherein each of the plurality of dielectric rod antennas comprises a radiating dielectric rod aperture.

9. The dielectric rod antenna assembly of claim 1, wherein the single waveguide is connected to each of the plurality of dielectric rod antennas.

10. The dielectric rod antenna assembly of claim 1, wherein the dielectric rod antenna assembly comprises a matching section located at an input of the plurality of dielectric rod antennas.

11. The dielectric rod antenna assembly of claim 1, wherein the plurality of dielectric rod antennas are spaced apart in a circular array.

12. The dielectric rod antenna assembly of claim 1, wherein the plurality of dielectric rods are spaced equidistantly in a circular array.

13. The dielectric rod antenna assembly of claim 1, wherein the plurality of dielectric rod antennas are arranged symmetrically in a circular array.

14. The dielectric rod antenna assembly of claim 1, wherein the plurality of dielectric rod antennas are arranged in radial symmetry.

15. The dielectric rod antenna assembly of claim 1, wherein the dielectric rod antennas are spaced apart in a square or rectangular array.

16. The dielectric rod antenna assembly of claim 1,
whereby a gain of the antenna assembly is greater than a gain of an antenna assembly having a single dielectric rod antenna, wherein each of the plurality of dielectric rod antennas and the single dielectric rod antenna are of equal length.

17. (canceled)

18. A parabolic reflector antenna system comprising the dielectric rod antenna assembly according to claim 1.

19. (canceled)

20. (canceled)
